(19) United States
(12) Patent Application Publication
(10) Pub. No.: US 2009/0217719 A1
(43) Pub. Date: Sep. 3, 2009

(54) KEY MECHANISM INTEGRATING A BEZEL AND A KEY

(76) Inventor: Chia-Hsin Liu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/168,905

(22) Filed: Jul. 8, 2008

(30) Foreign Application Priority Data
Feb. 29, 2008 (TW) 097107085

(51) Int. Cl. E05B 47/00

(52) U.S. Cl. 70/277; 70/344

(57) ABSTRACT

A key mechanism includes a bezel whereon an opening is disposed, a key installed inside the opening, at least one elastic structure connected to the bezel and the key, and a decoration ring sleeved between the bezel and the key and fixed on the bezel.

### BACKGROUND OF THE INVENTION

1. Field of the Invention

The present invention relates to a key mechanism and a related electronic device, and more particularly, to a key mechanism capable of integrating a bezel and a key and a related electronic device.

2. Description of the Prior Art

There are many kinds of key mechanisms for enhancing aesthetic feeling of a bezel. For example, please refer to FIG. 1. FIG. 1 is an exploded drawing of a key mechanism 10 in the prior art. The key mechanism 10 includes a bezel 12, a decoration ring 14, a spring 16, and a key 18. As for assembly of the key mechanism 10, the decoration ring 14 is installed on the bezel 12, the spring 16 is sheathed to the key 18, and the key 18 and the spring 16 are installed on the bezel 12 at last. The key mechanism 10 composed of four components (the bezel 12, the decoration ring 14, the spring 16, and the key 18) has disadvantages of cost and management of many components, laborious assembly, difficulty of positioning the spring 16, and non-uniformity of the gap between the key 18 and the decoration ring 14 resulting in decrease in aesthetic feeling of the key mechanism 10.

### SUMMARY OF THE INVENTION

It is therefore a primary objective of the invention to provide a key mechanism capable of integrating a bezel and a key and a related electronic device for solving the above-mentioned problem.

According to the claimed invention, a key mechanism includes a bezel whereon an opening is disposed, a key installed inside the opening, at least one elastic structure connected to the bezel and the key, and a decoration ring sleeved between the bezel and the key and fixed on the bezel.

According to the claimed invention, an electronic device includes a bezel whereon an opening is disposed, and a key mechanism including a key installed inside the opening on the bezel and at least one elastic structure connected to the bezel and the key.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded drawing of a key mechanism in the prior art.

FIG. 2 is a schematic drawing of an electronic device according to a preferred embodiment of the present invention.

FIG. 3 and FIG. 4 are exploded drawings of the key mechanism at different view angles according to the preferred embodiment of the present invention.

FIG. 5 is a schematic drawing of a decoration ring according to the preferred embodiment of the present invention.

FIG. 6 is an inner diagram of a bezel according to the preferred embodiment of the present invention.

FIG. 7 is a schematic drawing of the key mechanism having been assembled according to the preferred embodiment of the present invention.

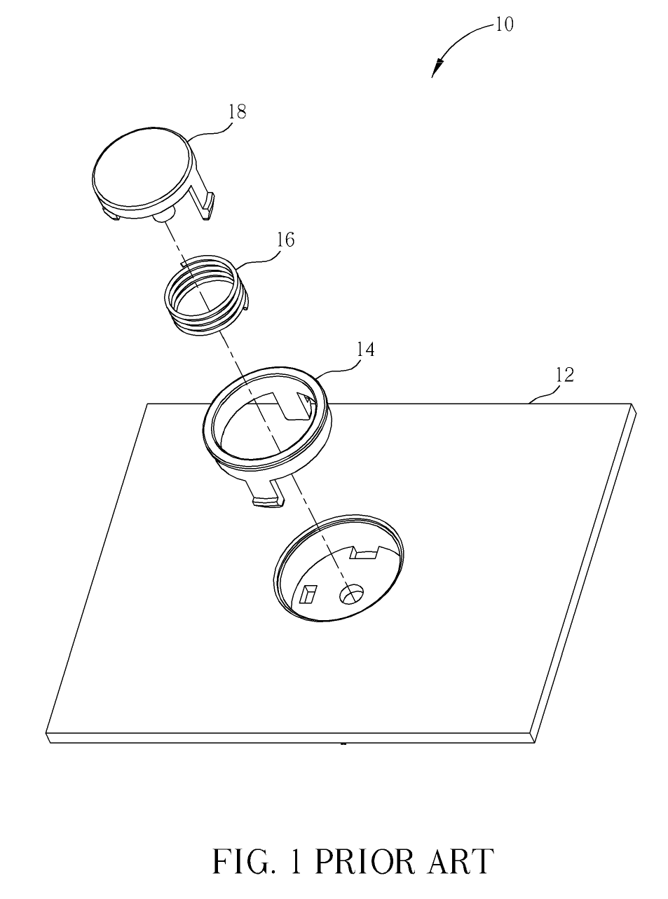

### DETAILED DESCRIPTION

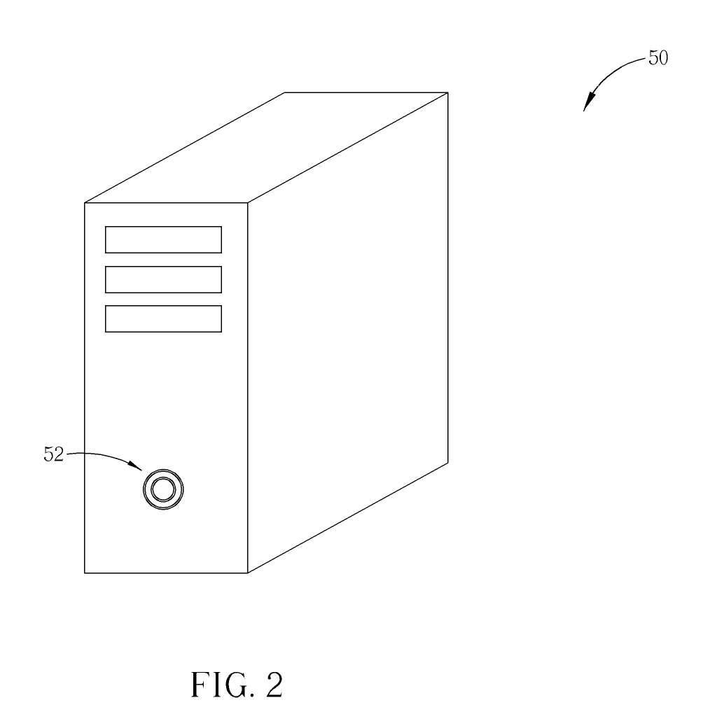

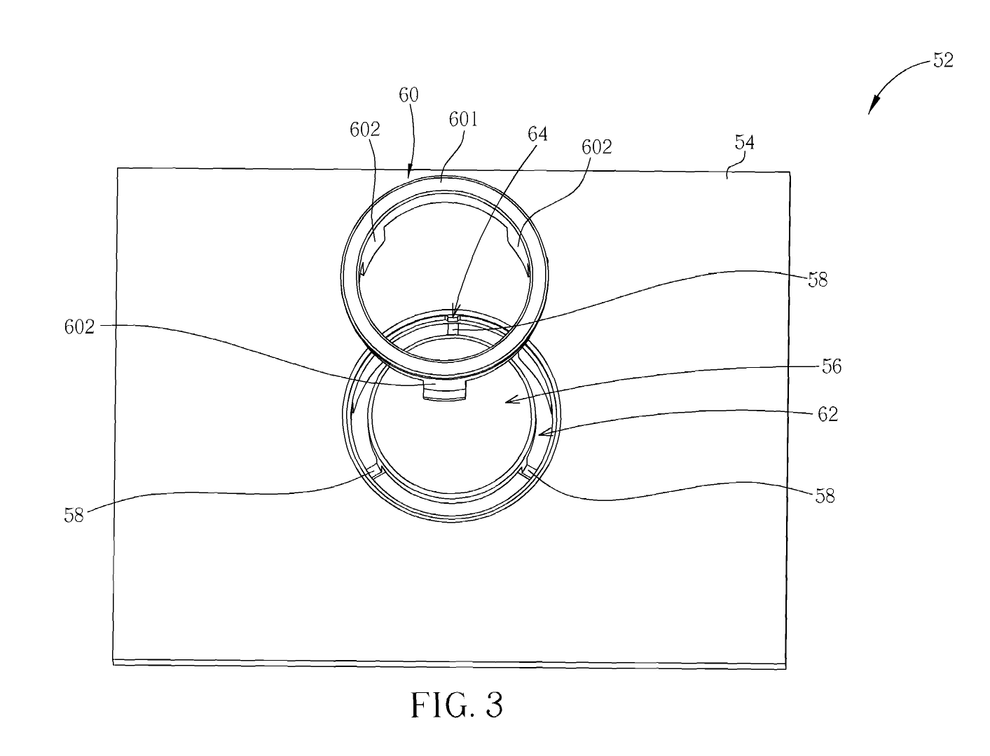

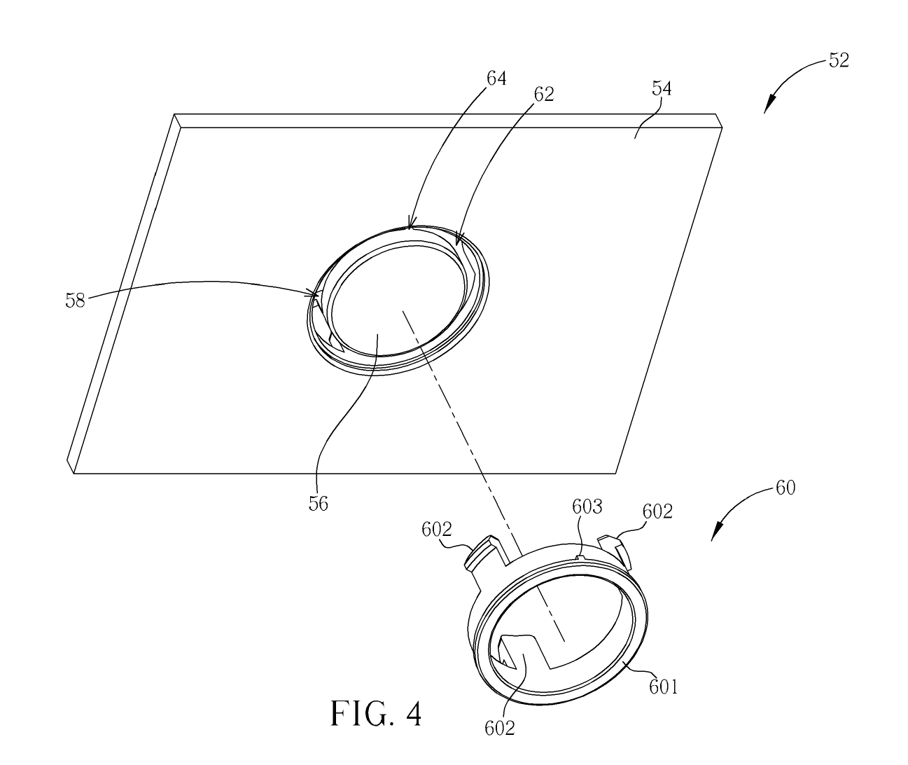

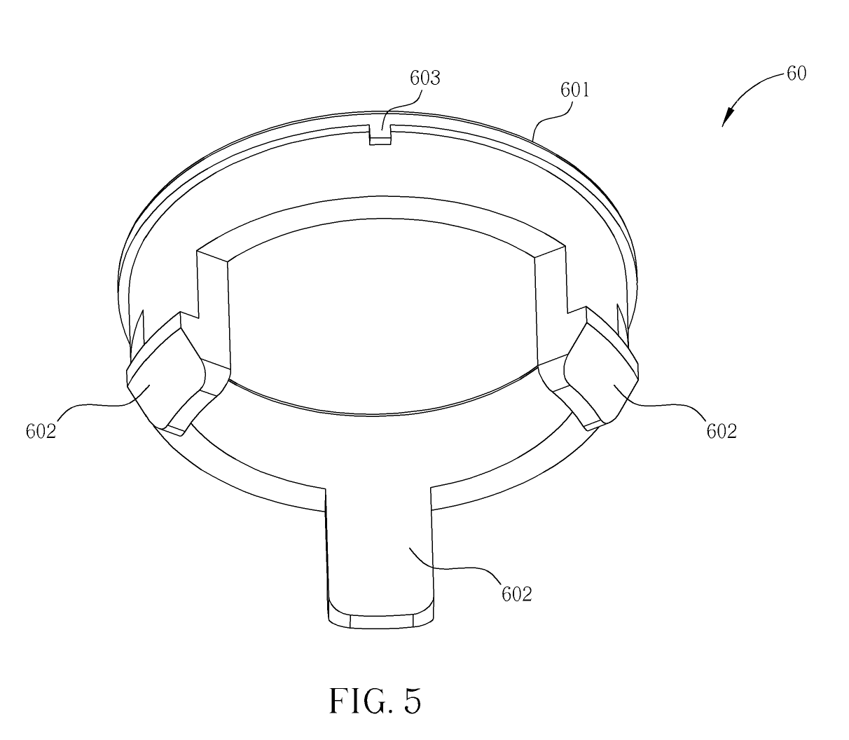

Please refer to FIG. 2. FIG. 2 is a schematic drawing of an electronic device 50 according to a preferred embodiment of the present invention. The electronic device 50 can be a computer host. The electronic device 50 includes a generally key mechanism 52 for inputting switch signals. The key mechanism 52 can be a power button mechanism. Please refer to FIG. 3 and FIG. 4, FIG. 3 and FIG. 4 are exploded drawings of the key mechanism 52 at different view angles according to the preferred embodiment of the present invention. The key mechanism 52 includes a bezel 54, a key 56, at least one elastic structure 58, and a decoration ring 60. An opening 62 and a notch 64 are formed on the bezel 54. The opening 62 can be a circular opening. The key 56 is installed inside the opening 62 on the bezel 54. The key 56 can be a circular key and can be a power button. The elastic structure 58 is connected to the bezel 54 and the key 56. The decoration ring 60 is sheathed between the bezel 54 and the key 56 and fixed to the bezel 54. Please refer to FIG. 5, FIG. 5 is a schematic drawing of the decoration ring 60 according to the preferred embodiment of the present invention. The decoration ring 60 includes a body 601 and at least one hook 602 connected to the body 301. The hook 602 can be made of elastic material. In this embodiment, the decoration ring 60 includes three hooks 602 disposed at an interval of approximately 120 degrees in an annular arrangement. The decoration ring 60 further includes a wedge 603 disposed in a position corresponding to the notch 64 for wedging in the notch 64.

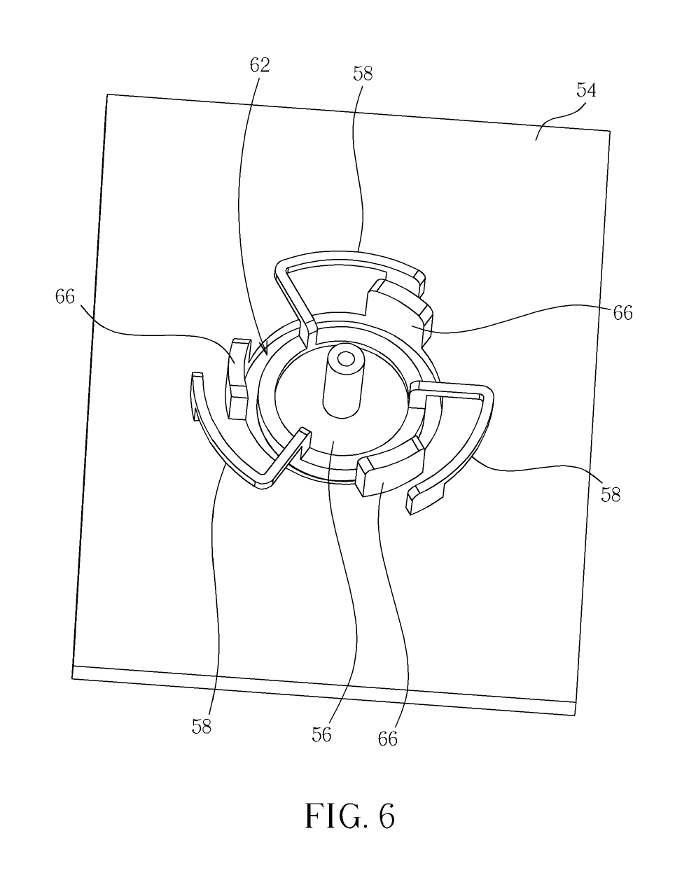

Please refer to FIG. 6, FIG. 6 is an inner diagram of the bezel 54 according to the preferred embodiment of the present invention. In this embodiment, three protrusions 66 are formed on an inner side of the bezel 54 and disposed at an interval of approximately 120 degrees in an annular arrangement. The key mechanism 58 includes three elastic structures 58 disposed at an interval of approximately 120 degrees in an annular arrangement and between the three protrusions 66 respectively. The elastic structure 58 can be an elastic rib. The bezel 54, the elastic structure 58, and the key 56 can be formed integrally. The number and disposition of the protrusions 66, the elastic structures 58, and the hooks 602 are not limited to this embodiment and can be designed according to design demand.

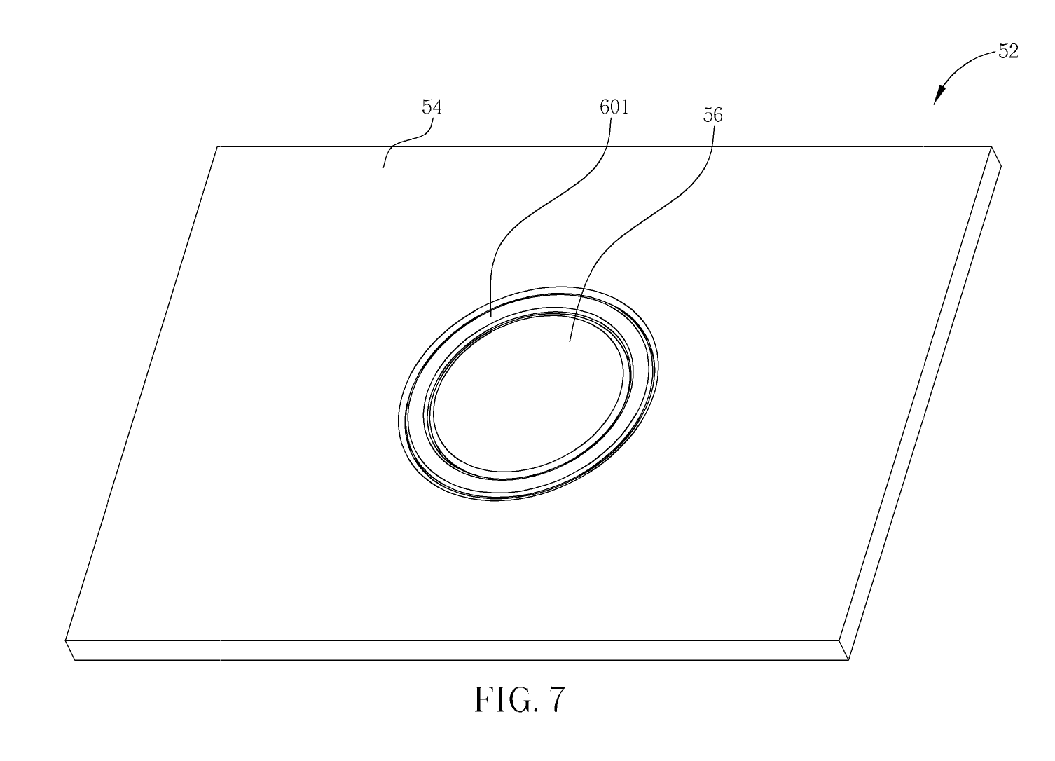

Please further referring to FIG. 3, FIG. 4, and FIG. 6, the wedge 603 of the decoration ring 60 and the notch 64 on the bezel 54 are for foolproof design as a positioning reference point of assembly. That is, when the wedge 603 aims at the notch 64, each hook 602 is positioned corresponding to each protrusion 66. When the wedge 603 wedges in the notch 64 for sheathing the decoration ring 60 inside the opening 64 between the bezel 54 and the key 56, the hooks 602 bends due to interference of an end thereof and the protrusion 66 until the decoration ring 60 has sheathed in the opening 64 between the bezel 54 and the key 56 completely. After the decoration ring 60 has sheathed in the opening 64 between the bezel 54 and the key 56 completely, the hook 602 restores to an original situation elastically so as to wedge with the protrusion 66 for fixing the decoration ring 60 on the bezel 54 stably. Please refer to FIG. 7, FIG. 7 is a schematic drawing of the key mechanism 52 having been assembled according to the preferred embodiment of the present invention. The body 601 of the decoration ring 60 is fixed between the bezel 54 and the key 56 stably after assembling the key mechanism 52 so as to present integral aesthetic feeling of the bezel 54, the key 56, and the decoration ring 60.

In conclusion, the key mechanism 52 of the present invention integrates the bezel 54 and the key 56 via the elastic structure 58 for replacing a conventional spring so that there is only a need to sheath the decoration ring 60 in the bezel 54. The key mechanism 52 of the present invention has advantages of effectively reducing cost and management of components, easy assembly, no need of positioning the conventional spring, and uniformity of the gap between the key 56 and the decoration ring 60 resulting in increase in aesthetic feeling of the key mechanism 52.

In contrast to the conventional key mechanism, the key mechanism of the present invention integrates the bezel and the key via the elastic structure so as to effectively reduce cost and management of components, assemble the key mechanism easily, and keep uniformity of the gap between the key and the decoration ring resulting in increase in aesthetic feeling of the key mechanism.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A key mechanism comprising:
a bezel with an opening;
a key installed inside the opening on the bezel; and
at least one elastic structure connected to the bezel and the key.

2. The key mechanism of claim 1 further comprising a decoration ring sheathed between the bezel and the key and fixed to the bezel.

3. The key mechanism of claim 1 wherein the elastic structure is an elastic rib.

4. The key mechanism of claim 1 comprising three elastic structures disposed at an interval of approximately 120 degrees in a general annular arrangement.

5. The key mechanism of claim 2 wherein at least one protrusion is formed on the bezel, and the decoration ring comprises a body and a hook connected to the body for wedging in the protrusion when the decoration ring sheathes between the bezel and the key.

6. The key mechanism of claim 5 wherein the hook is made of elastic material.

7. The key mechanism of claim 5 wherein three protrusions are formed on the bezel and disposed at an interval of approximately 120 degrees in an annular arrangement, and the decoration ring comprises three hooks disposed at an interval of approximately 120 degrees in a general annular arrangement.

8. The key mechanism of claim 7 comprising three elastic structures disposed at an interval of approximately 120 degrees in an generally annular arrangement and between the three protrusions respectively.

9. The key mechanism of claim 5 wherein a notch is formed on the bezel, and the decoration ring further comprises a wedge disposed in a position corresponding to the notch for wedging in the notch when the hook wedges in the protrusion.

10. The key mechanism of claim 2 wherein a notch is formed on the bezel, and the decoration ring further comprises a wedge disposed in a position corresponding to the notch for wedging in the notch.

11. The key mechanism of claim 1 wherein the opening is a circular opening and the key is a substantially circular key.

12. An electronic device comprising:
a bezel whereon an opening is disposed; and
a key mechanism comprising:
a key installed inside the opening on the bezel; and
at least one elastic structure connected to the bezel and the key.

13. The electronic device of claim 12 further comprising a decoration ring sheathed between the bezel and the key and fixed to the bezel.

14. The electronic device of claim 12 wherein the elastic structure is an elastic rib.

15. The electronic device of claim 12 comprising three elastic structures disposed at an interval of approximately 120 degrees in a generally annular arrangement.

16. The electronic device of claim 13 wherein at least one protrusion is formed on the bezel, and the decoration ring comprises a body and a hook connected to the body for wedging in the protrusion when the decoration ring sheathes between the bezel and the key.

17. The electronic device of claim 16 wherein the hook is made of elastic material.

18. The electronic device of claim 16 wherein three protrusions are formed on the bezel and disposed at an interval of approximately 120 degrees in an annular arrangement, and the decoration ring comprises three hooks disposed at an interval of approximately 120 degrees in a generally annular arrangement.

19. The electronic device of claim 18 comprising three elastic structures disposed at an interval of approximately 120 degrees in an annular arrangement and between the three protrusions respectively.

20. The electronic device of claim 16 wherein a notch is formed on the bezel, and the decoration ring further comprises a wedge disposed in a position corresponding to the notch for wedging in the notch when the hook wedges in the protrusion.

21. The electronic device of claim 13 wherein a notch is formed on the bezel, and the decoration ring further comprises a wedge disposed in a position corresponding to the notch for wedging in the notch.

22. The electronic device of claim 12 wherein the key is a power button.
